(19) United States
(12) Patent Application Publication
(10) Pub. No.: US 2010/0205262 A1
(43) Pub. Date: Aug. 12, 2010

(54) System, method and computer-readable medium for provision of real time support to a computer user

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 12/378,044

(22) Filed: Feb. 9, 2009

(51) Int. Cl. G06F 15/16; H04L 12/66

(52) U.S. Cl. 709/206; 370/352; 709/204

(57) ABSTRACT

A system, method and computer-readable media for enabling verbal communications between a computer user and a support representative are provided. In a computer network comprising a computer and a support workstation, the method includes (a.) receiving a support request at a workstation via a computer network, (b.) initiating a communications session between the computer and the workstation; and (c.) establishing a real time verbal discussion between a user of the computer and an operator of the workstation, wherein the operator attempts to support the user in achieving a goal by means of the computer network. Optionally, the support representative may send and/or receive graphical and textual information, to include screen shots and graphical user interface instructions.

### FIELD OF THE INVENTION

The present invention relates to the use of information technology systems. More particularly, the present invention relates to the provision of help and guidance to a human operator of an information technology system.

### BACKGROUND

Information technology is presently available to a wide variety of users of differing skill levels and learning styles. Some users learn efficiently by searching the Internet through textual querying of search engines websites such as GOOGLE.COM™. Other learners prefer direct interaction with a human guide.

Many information technology users desire access to real-time technical support in order to address problems or concerns that arise during use of an information technology system. These needs can be urgent and cause emotional distress in the user. Providers of information technology can achieve a competitive advantage by more rapidly addressing the informational and emotional needs of IT users than their competitors.

As one example of providing user support as an aspect of a product, General Motors Corporation of Flint Mich. currently provides an Internet based communications service that is marketed as the ONSTAR™ customer support communications service. An occupant of an ONSTAR enabled vehicle may communicate by voice with a human support representative to request help or information. The ONSTAR service can address a traveler's desire to obtain specific local information that is useful to the traveler, such as locations of rest stops, fueling stations and medical facilities. At times the traveler's needs may be urgent and the ONSTAR service offers rapid availability to suddenly valuable information.

Users of personal computers, wireless communications enabled personal digital assistants (hereinafter “PDA's”) and cellular phones also occasionally have, sometimes urgent, informational needs regarding the use of their information technology systems. Cellular phones offer the capability of verbal customer support, and Internet connected personal computers and PDA's that are configured to enable Voice over Internet Protocol technology can support verbal communication links. Connecting a user of a product or service directly and promptly with a customer service representative can offer an opportunity for additional sales to the user and to increase customer satisfaction with the vendors goods and services.

There is therefore a long felt need to provide an IT user with a more convenient and satisfying access to a customer support service by voice communications.

### SUMMARY

The present invention meets the above needs and overcomes one or more deficiencies in the prior art by providing systems and methods for delivering real time support to a an IT system user by establishing a bi-directional communications session between the user and a human customer service representative or support agent or technician. The communications session may enable verbal communications between the user and a customer service representative or support agent or technician.

In another aspect of the invention, the customer service representative or support agent or technician may be provided with visual images of the display image presented to the user by the IT system. In yet another aspect of the invention, the user may transmit textual messages to the customer service representative or support agent or technician (or “operator”). According to additional aspects of the invention, services used to wholly or partially enable voice, text and graphics data communication between the user and the customer service representative or support agent or technician include cellular telephone services, broadband internet services, cable or satellite television services, Foreign Exchange Office (or “FXO”) lines available on a PC via a voice modem (FXO is an interface for VoIP devices to connect to standard Private Branch Exchange systems found in many offices), SKYPE™ Voice over Internet Protocol service and SKYPEOUT Voice over Internet Protocol service available on a computer, and Public Switched Telephone Network termination services.

These and various other features, as well as advantages, which characterize the present invention, will be apparent from a reading of the following detailed description and a review of the associated drawings.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### INCORPORATION BY REFERENCE

All publications, patents, and patent applications mentioned in this specification are herein incorporated by reference to the same extent as if each individual publication, patent, or patent application was specifically and individually indicated to be incorporated by reference. U.S. Pat. No. 6,938,000 (Inventors: Joseph, et al.; issued on Aug. 30, 2005) titled “Automated customer support system”; U.S. Pat. No. 7,170,979 (Inventors: Byrne, et al.; issued on Jan. 30, 2007) titled “System for embedding programming language content in voiceXML”; U.S. Pat. No. 7,292,689 (Inventors: Odinak, et al.; issued on Nov. 6, 2007) titled “System and method for providing a message-based communications infrastructure for automated call center operation”; U.S. Pat. No. 7,391,860 (Inventors: Odinak, et al.; issued on Jun. 24, 2008) titled “Method for providing a message-based communications infrastructure for automated call center operation”; U.S. Pat. No. 7,409,221 (Inventors: Obradovich, et al.; issued on Aug. 5, 2008) titled “Technique for communicating information concerning a product or service provider to a vehicle”; and U.S. Pat. No. 7,417,559 (Inventor: Janke, G.; issued on Aug. 26, 2008) titled “Method and system for vehicular communications and information reporting” are incorporated herein by reference in their entirety and for all purposes.

United States Patent Application Publication No. 20070265873 (Inventors: Sheth, Urvashi, et al.; published on Nov. 15, 2007) titled “Method and system for online customer relationship management”; United States Patent Application Publication No. 20080056233 (Inventors: Ijidakinro, Ayodele A., et al.; published on Mar. 6, 2008) titled “Support Incident Routing”; United States Patent Application Publication No. 20080056460 (Inventors: Odinak, Gilad, et al.; published on Mar. 6, 2008) titled “Method for providing a message-based communications infrastructure for automated call center operation”; United States Patent Application Publication Ser. No. 20080077873 (Peterson, Harold Lee; published Mar. 27, 2008) entitled “Apparatus, method and computer-readable medium for organizing the display of visual icons associated with information technology processes”; and U.S. patent application Ser. No. 09/423,025 (Peterson, H. L., et al.; filed on Oct. 28, 1999) entitled “Digital content vending, delivery and maintenance system” are each incorporated herein by reference in their entirety and for all purposes.

### BRIEF DESCRIPTION OF THE SEVERAL VIEWS OF THE DRAWINGS

The present invention is described in detail below with reference to the attached drawing figures, wherein:

FIG. 1 is a schematic of an electronics communications network including a client computer and a customer relationship management workstation;

FIG. 2 is a schematic diagram of the client computer of FIG. 1;

FIG. 3 is a schematic diagram of the workstation of FIG. 1;

FIG. 4 is a flowchart of a first aspect of the method of the present invention, wherein voice over Internet Protocol is enabled by the network of FIGS. 1 and 2;

FIG. 5 is a flowchart of a second aspect of the method of the present invention, wherein voice over Internet Protocol is processed and employed by the workstation of FIGS. 1 and 3;

FIG. 6 is a schematic diagram of a plurality of software elements of the client computer of FIG. 1, according to a third aspect of the method of the present invention;

FIG. 7 is a schematic diagram of a plurality of software elements of the workstation of FIG. 1, according to a fourth aspect of the method of the present invention;

FIG. 8 is an illustration of a display screen image of the client computer of FIGS. 1 and 2, according to a fifth aspect of the method of the present invention;

FIG. 9 is an illustration of a display screen image of the workstation of FIGS. 1 and 3, according to a sixth aspect of the method of the present invention:

FIG. 10 is a schematic drawing of an electronic message formatted for transmission within the network of FIG. 1 and optionally between the client computer 4 of FIGS. 1, 2 and 6, and the workstation of FIGS. 1, 3 and 7;

FIG. 11 is a schematic drawing of a user record of the user database of the customer relationship management workstation 6 of FIGS. 1, 3 and 7;

FIG. 12 is a schematic drawing of a product record of the product database of the workstation of FIGS. 1, 3 and 7; and

FIG. 13 is a schematic drawing of a serialized record of the product database of the workstation of FIGS. 1, 3 and 7.

### DETAILED DESCRIPTION

The present invention provides an improved system, method and computer-readable medium for the management of the visual presentations of icons by a computer. An exemplary operating environment for the present invention is described below. The subject matter of the present invention is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

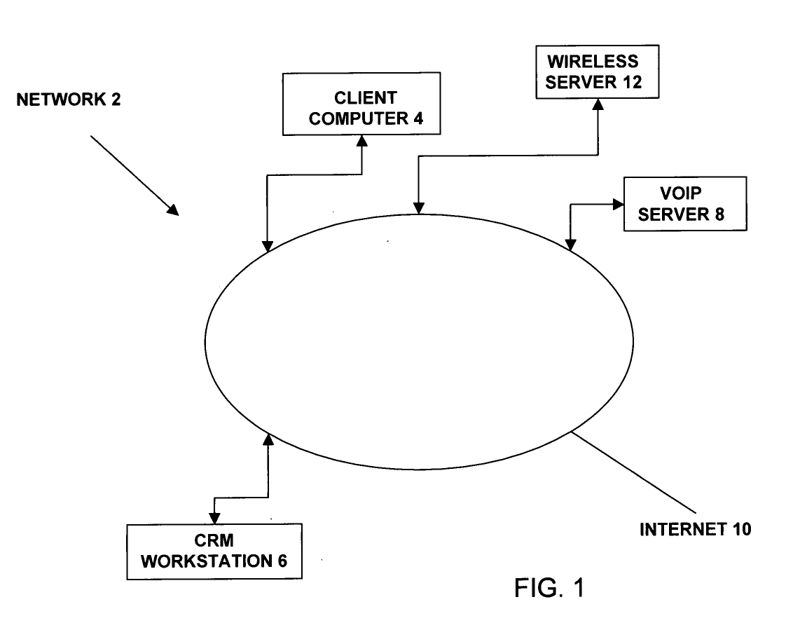

Referring now to the attached drawings, which are incorporated in their entirety by reference herein and in which like numerals represent like elements, various aspects of the present invention will be described. In particular, FIG. 1 and the corresponding discussion are intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, microprocessor-based cellular telephones, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now generally to the Figures and particularly to FIG. 1, an electronics communications network 2 bi-directionally communicatively couples a client computer 4 and a customer relationship management workstation 6 (hereinafter, “CRM workstation” 6). The client computer 4 and the CRM workstation 6 are enabled for Voice-over Internet Protocol (or, “VoIP”) communications, and optionally for transmission of video, graphic and/or text data. In certain applications of the method of the present invention, a third party VoIP service, such as SKYPE™ VoIP service may be employed to enable voice and optionally video, text and/or text data communications. The electronics communications network 2 (hereinafter “the network” 2) may optionally comprise the Internet 10 and/or a wireless communications server 12. The wireless server 12 may be or comprise a wireless communications switch or router that bi-directionally communicatively couples the client computer 4 and/or the CRM workstation 6 with the network 2 and/or the Internet 10.

The CRM workstation 6 may be used by a customer service representative or support agent or technician (hereinafter “operator”).

The client computer 4, or “computer” 4 may be or comprise an electronic computer system, an information appliance configured for wireless Internet-enabled communication, a television set-top box, and/or a wireless communications capable communications device, such as (a.) a VAIO FS8900™ notebook computer marketed by Sony Corporation of America, of New York City, N.Y., (b.) a wireless communications enabled SUN SPARCSERVER™ computer workstation marketed by Sun Microsystems of Santa Clara, Calif. running LINUX™ or UNIX™ operating system; (c.) a wireless communications enabled personal computer configured for running WINDOWS XP™ or VISTA™ operating system marketed by Microsoft Corporation of Redmond, Wash.; (d.) a PowerBook G4™ personal computer as marketed by Apple Computer of Cupertino, Calif.; (e.) an iPhone™ cellular telephone as marketed by Apple Computer of Cupertino, Calif.; or (f.) a personal digital assistant enabled for wireless communications.

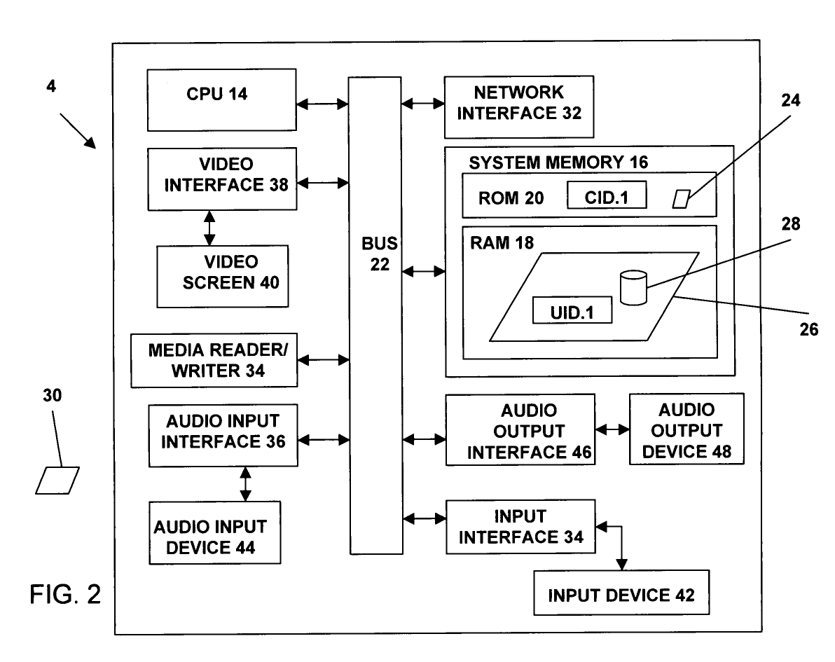

FIG. 2 is a schematic diagram of the client computer 4 of FIG. 1. The computer architecture shown in FIG. 2 illustrates the computer 4, including a central processing unit 14 (hereinafter, “CPU”), a system memory 16, including a random access memory 18 (hereinafter, “RAM”) and a read-only memory (hereinafter, “ROM”) 20, and a system bus 22 that couples the system memory 16 to the CPU 14. A basic input/output system 24 containing the basic software-encoded instructions and routines that help to transfer information between elements within the computer 4, such as during startup, is stored in the ROM 20. The computer 4 further includes a system software 26 and a database management system 28 (hereinafter “DBMS” 28), which will be described in greater detail below, stored in the system memory 16 and/or a computer-readable medium 30.

A media writer/reader 32 is bi-directionally communicatively coupled to the CPU 14 through the bus 22. The media writer/reader 32 and the associated computer-readable media 30 are selected and configure to provide non-volatile storage for the computer 4. Although the description of computer-readable media 30 contained herein refers to a mass storage device, such as a hard disk or CD-ROM drive, it should be appreciated by those skilled in the art that computer-readable media can be any available media that can be accessed by the computer 4.

By way of example, and not limitation, computer-readable media 30 may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 4.

The computer-readable medium 30 may comprise machine-readable instructions which when executed by the computer 4 to cause the computer 4 to perform one or more steps as described in the Figures and enabled by the present disclosure.

The bus 22 further bi-directionally communicatively couples a network interface 32, a user input interface 34, a user audio input interface 36, and a video screen interface 38 with the CPU 14 and the system memory 16. The video screen interface 38 directs visual presentations of data on a visual display screen 40 and bi-directionally communicatively couples the visual display screen 40 with the CPU 14 via the communications bus 14.

The user input interface 34 couples a user input device 42, such as an electronic keyboard, a computer mouse, a computer trackball, or a computer mousepad, with the CPU 14 via the communications bus 14 and enables the user to input icon selections, commands and data to the computer 4. The icon selections may be chosen from images presented on the visual display screen 40.

The audio input interface 36 couples a user audio input device 44, such as an audio microphone, with the CPU 14 via the communications bus 22 and enables the user to input vocal input that communicates icon selections, commands and data to the computer 4, and/or digitized representations of verbal expressions. The digitized representations of verbal expressions may be transmitted via the network interface 32 to enable VoIP communications with the CRM workstation 6 and thereby with the CRM operator.

An audio output interface 34 communicatively coupled with the communications bus 22 receives digitized verbal information, such as VoIP messages, from the network 2 via network interface 32 and drives the audio output device 48 to audibly output verbal message derived from the digitized verbal communications.

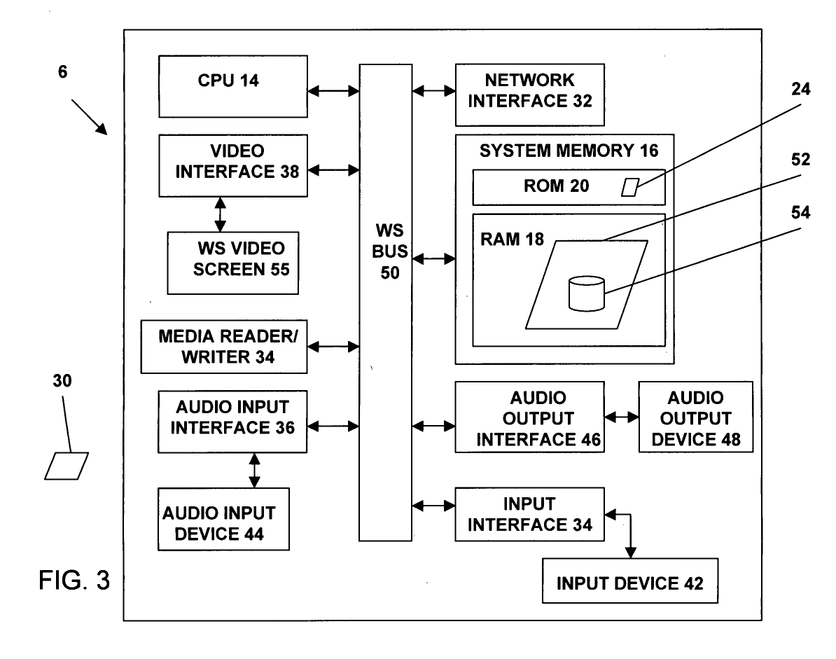

FIG. 3 is a schematic diagram of the CRM workstation 6 of FIG. 1. The CRM workstation 6 may be or comprise an electronic computer system configured for bi-directional communications with the network 2, such as (a.) a SUN SPARCSERVER™ computer workstation marketed by Sun Microsystems of Santa Clara, Calif. running LINUX™ or UNIX™ operating system; (b.) a server or personal computer configured for running WINDOWS XP™ or VISTA™ operating system marketed by Microsoft Corporation of Redmond, Wash.; (c.) a PowerBook G4™ personal computer as marketed by Apple Computer of Cupertino, Calif.; (d.) an information appliance configured for Internet-enabled communication; and (e.) a wireless communications-enabled communications device.

The computer architecture shown in FIG. 2 illustrates the CRM workstation 6, including the CPU 14, the system memory 16, including the RAM 18 and the ROM 20, and a workstation communications system bus 50 (hereinafter, “WS bus” 50) that couples the system memory 16 to the CPU 14. The basic input/output system 24 containing the basic software-encoded instructions and routines that help to transfer information between elements within the computer 4, such as during startup, is stored in the ROM 20. The computer 4 further includes a workstation system software 52 and a CRM database management system 54 (hereinafter “CRM DBMS” 54), which will be described in greater detail below, stored in the system memory 16 and/or the computer-readable medium 30.

The media writer/reader 32 is bi-directionally communicatively coupled to the CPU 14 through the WS bus 50. The media writer/reader 32 and the associated computer-readable media 30 are selected and configure to provide non-volatile storage for the CRM workstation 6. Although the description of computer-readable media 30 contained herein refers to a mass storage device, such as a hard disk or CD-ROM drive, it should be appreciated by those skilled in the art that computer-readable media can be any available media that can be accessed by the computer 4.

The computer-readable medium 30 may comprise machine-readable instructions which when executed by the CRM workstation 6 to cause the CRM workstation 6 to perform one or more steps as described in the Figures and enabled by the present disclosure.

The WS bus 50 further bi-directionally communicatively couples the network interface 32, the audio input interface 34, the audio input interface 36, and the video screen interface 38 with the CPU 14 and the system memory 16. The video screen interface 38 directs visual presentations of data on a workstation visual display screen 55 (hereinafter, “WS display” 55) for access by a CRM operator and bi-directionally communicatively couples the WS display 55 with the CPU 14 via the communications bus 14.

The input interface 34 couples the input device 42, such as an electronic keyboard, a computer mouse, a computer trackball, or a computer mousepad, with the CPU 14 via the communications bus 14 and enables the CRM operator to input icon selections, commands and data to the computer 4. The icon selections may be chosen by the CRM operator from images presented on the WS display screen 55.

The audio input interface 36 couples the audio input device 44, such as an audio microphone, with the CPU 14 via the communications bus 22 and enables the CRM operator to input vocal input that communicates icon selections, commands and data to the CRM workstation 6, and/or digitized representations of verbal expressions. The digitized representations of verbal expressions may be transmitted via the network interface 32 to enable VoIP communications with the computer 4.

The audio output interface 34 communicatively coupled with the WS bus 50 receives digitized verbal information, such as VoIP messages, from the network 2 via network interface 32 and drives the audio output device 48 to audibly output verbal message derived from the digitized verbal communications for acoustic perception by the CRM operator.

It is understood that the VoIP server 8 may include one or more of the elements or aspects 14-54 of the computer 4 and/or the CRM workstation 6 and as further described below.

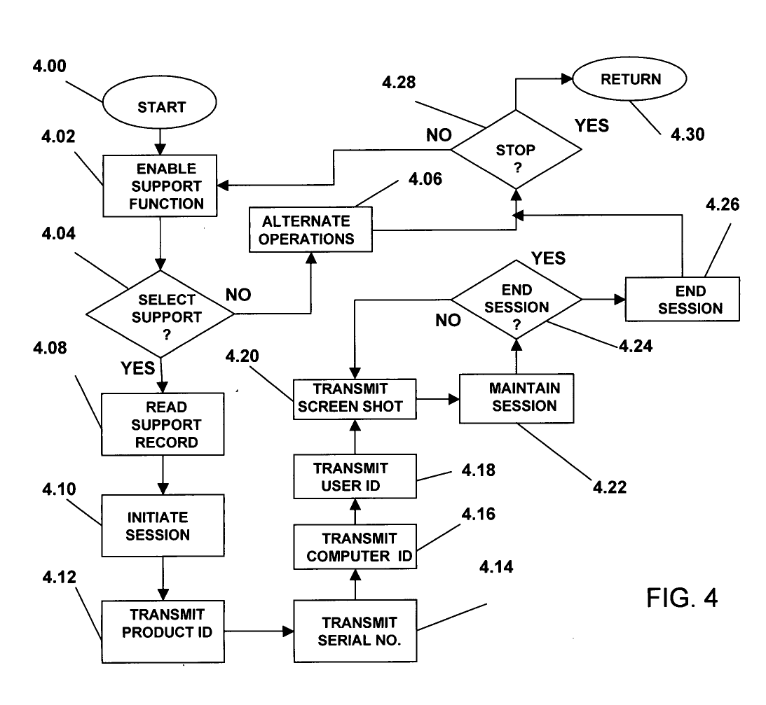

Referring now to FIG. 4, FIG. 4 is a flowchart of processing activity of the computer 4 according to a first aspect of the method of the present invention. The computer 4 is powered up in step 4.00 and in step 4.02 a support function associated with a first application software A.1 is enabled. In step 4.04 the computer 4 determines whether the support function has been selected for access by the user, and the computer proceeds to step 4.06 when the computer 4 determines in step 4.04 that the support function of step 4.02 shall not be employed and to perform alternate operations. Alternatively, when the computer 4 determines in step 4.04 that the support function of step 4.02 has been selected for access by the user, the computer 4 proceeds from step 4.04 to step 4.08 and to read a support record S.1 from the system memory 16 of the computer 4. The support record S.1 as described further herein, may associate the first application software A.1 with one or more support call addresses ADDR.1 and ADDR.2, a product identifier P.1 of the first application software A.1, a first serial number SN.1 of a license or of a copy of software-encoded instructions associated with the first application software A.1 of the computer 4, an identifier of the computer 4 CID.1, and/or an identifier of the user UID.1. The computer 4 initiates a bi-directional, real-time audio communications session in step 4.10 with the CRM workstation 6 by directing an initiating message to the CRM workstation 6, the VoIP Server 8 and/or the wireless server 12. The computer 4 transmits the product identifier P.1 to the CRM workstation 6 in optional step 4.12; the computer 4 transmits the first serial number SN.1 to the CRM workstation 6 in optional step 4.14; the computer 4 transmits the computer identifier C.1 to the CRM workstation 6 in optional step 4.16; the computer 4 transmits the user identifier U.1 to the CRM workstation 6 in optional step 4.18. And in step 4.20 the computer 4 further transmits a screen shot of an image presented on the video screen 40 of the computer 4.

It is understood that the transmissions of data of steps 4.12 through 4.20 may be addressed directly to the CRM workstation 6, and/or indirectly addressed and passing through the VoIP Server 8 and/or the wireless server 12 en route to final delivery to the CRM workstation 6.

The computer 4 maintains the bi-directional communications session between the computer 4 and the CRM workstation 6 in step 4.22, and determines whether to end the bi-directional communications session in step 4.24. The computer 4 may determine to end the communications between the computer 4 and the CRM workstation 6 on the basis of the of a session cessation command issued by the computer 4 or the CRM workstation 6. When the computer 4 determines to not end the communications between the computer 4 and the CRM workstation 6 in step 4.24, the computer 4 proceeds from step 4.24 to step 4.20 and to transmit a current screen shot of the video screen 40 to the CRM workstation 6 via the network 2. When the computer 4 determines to end the communications between the computer 4 and the CRM workstation 6 in step 4.24, the computer 4 proceeds from step 4.24 to step 4.26 to end the audio communications session initiated in step 4.10.

The computer 4 proceeds from step 4.26 to step 4.28 wherein to whether to end the processing of the first software application A.1. When the computer 4 determines in step 4.28 to cease running the first software application A.1, the computer 4 proceeds from step 4.28 and to step 4.30 wherein the computer 4 ceases running the first software application A.1 and initiates alternate processing operations. When the computer 4 determines in step 4.28 to continue running the first software application A.1, the computer 4 proceeds from step 4.28 to step 4.02. According to one aspect of the method of the present invention, electronic messages sent from the client computer 4 and addressed according to a first support call address ADDR.1 are transmitted via the network 2 to the CRM workstation 6, to include electronic messages bearing audio data recorded from vocal inputs detected by the audio input device 44 and digitized by the audio input interface 36. According to another aspect of the method of the present invention, electronic messages sent from the client computer 4 and addressed according to a second support call address ADDR.2 are transmitted via the network 2 to the VoIP server 8 and/or the wireless server 12, to include electronic messages bearing audio data recorded from vocal inputs detected by the audio input device 44 and digitized by the audio input interface 36. Electronic messages sent from the client computer 4 and addressed to the second support call address ADDR.2 may include the first support call address ADDR.1 and/or include a command to forward a payload of the electronic messages to the CRM workstation 6.

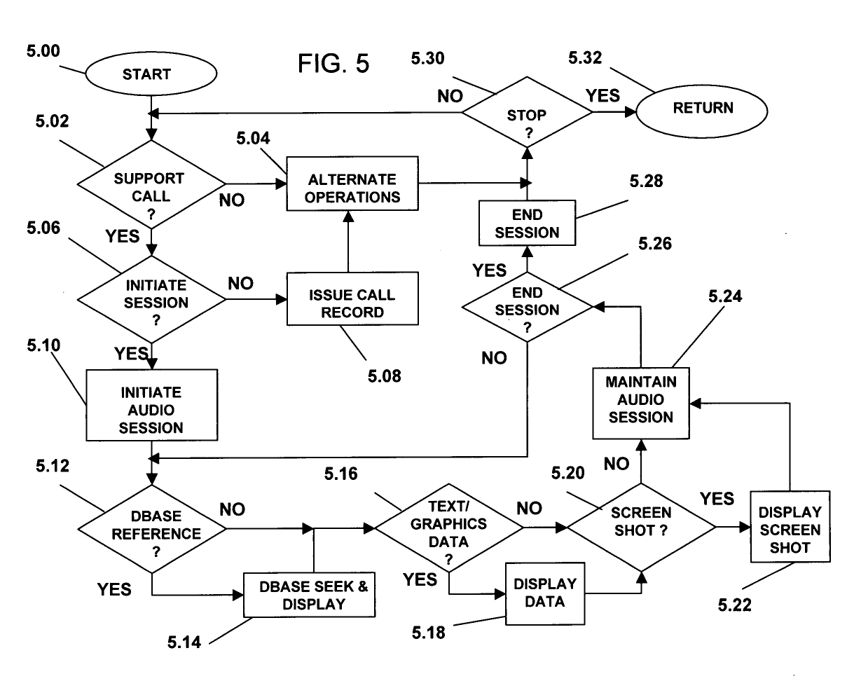

Referring now to FIG. 5, FIG. 5 is a software flowchart of possible computational processing by the CRM workstation 6 in accordance with a second aspect of the method of the present invention. In step 5.0 the CRM workstation 6 is powered up and determines in step 5.02 whether a support call requesting a real time, bi-directional audio communications session has been received via the network 2. It is understood that the support call may be originated by the computer 4 and received via the VoIP Server 8 and/or the wireless server 12. When CRM workstation 6 determines in step 5.02 that a new support call has not been received, the CRM workstation 6 proceeds on to step 5.04 and to perform alternate operations. When CRM workstation 6 determines in step 5.02 that a new support call has been received via the network 2, the CRM workstation 6 proceeds on to step 5.06 to determines whether the operator has directed the CRM workstation 6 to initiate a real-time, bi-directional audio communications session with the computer 4. When the CRM workstation 6 determines in step 5.06 that the operator has not directed the CRM workstation 6 to initiate a bi-directional communications session with the computer 4, the CRM workstation 6 proceeds on to step 5.8 to issue a call record of the support call. The CRM workstation 6 proceeds from step 5.08 to step 5.04 to perform alternate operations, such as issuing a receipt of the call record to the computer 4 via the network 2.

When the CRM workstation 6 determines in step 5.06 that the operator has directed the CRM workstation 6 to initiate a bi-directional communications session with the computer 4, the CRM workstation 6 proceeds on to step 5.10 and initiate a bi-directional audio communications session that may optionally employ VoIP techniques, modules and equipment.

The CRM workstation 6 determines in step 5.12 whether the computer 4 has communicated a reference to a database record to the CRM workstation 6, such as the product identifier P.1 of the first software application, the first serial number SN.1 of the first software application, the computer identifier C.1 of the computer 4 and/or the user identifier U.1. When the CRM workstation 6 determines in step 5.12 that a database reference, or “DBASE REFERENCE”, has been sent from the computer 4 and received by the CRM workstation 6, the CRM workstation 6 (a.) directs the CRM DBMS 54 to information associated with the received database reference P.1, SN.1, C.1, and/or U.1; and (b.) displays any associated information discovered by the CRM DBMS 54 on the WS display 55 of the CRM workstation 6. The CRM workstation 6 determines in step 5.16 whether the computer 4 has communicated any textual or graphics data to the CRM workstation 6 in reference to the support call of step 5.02, and displays any received textual or graphics data on the WS display 55 of the CRM workstation 6 in step 5.18. The CRM workstation 6 determines in step 5.20 whether the computer 4 has communicated any screen shot image data to the CRM workstation 6 in reference to the support call of step 5.02, and displays any received screen shot image data on the WS display 55 of the CRM workstation 6 in step 5.22.

The CRM workstation 6 maintains in step 5.24 the bidirectional audio session initiated in step 5.06 and determines in step and determines whether to end the communications session in step 5.26. The CRM workstation 6 may determine to end the communications between the computer 4 and the CRM workstation 6 on the basis of the of a session cessation command received the CRM workstation 6 and sent from the computer 4 and/or issued by the operator.

When the CRM workstation 6 determines to not end the communications between the computer 4 and the CRM workstation 6 in step 5.26, the computer 4 proceeds from step 5.26 to step 5.12 and to cycle through again from step 5.12 to step 5.26. When the 6 determines to end the communications session between the computer 4 and the CRM workstation 6 in step 5.26, the computer 4 proceeds from step 5.26 to step 5.28 and to end the bidirectional communications session initiated in step 5.06.

The CRM workstation 6 determines in step 5.20 whether to continue to accept support calls from the network 2. When the CRM workstation 6 determines in step 5.30 to cease accepting support calls from the network 2 proceeds from step 5.30 and to step 5.32 wherein the CRM workstation 6 ceases proceeds on to alternate processing operations. When the CRM workstation 6 determines in step 4.26 to continue accepting support calls from the network 2, the CRM workstation 6 proceeds from step 4.30 to step 5.02, and to cycle through again from step 5.02 to step 5.30.

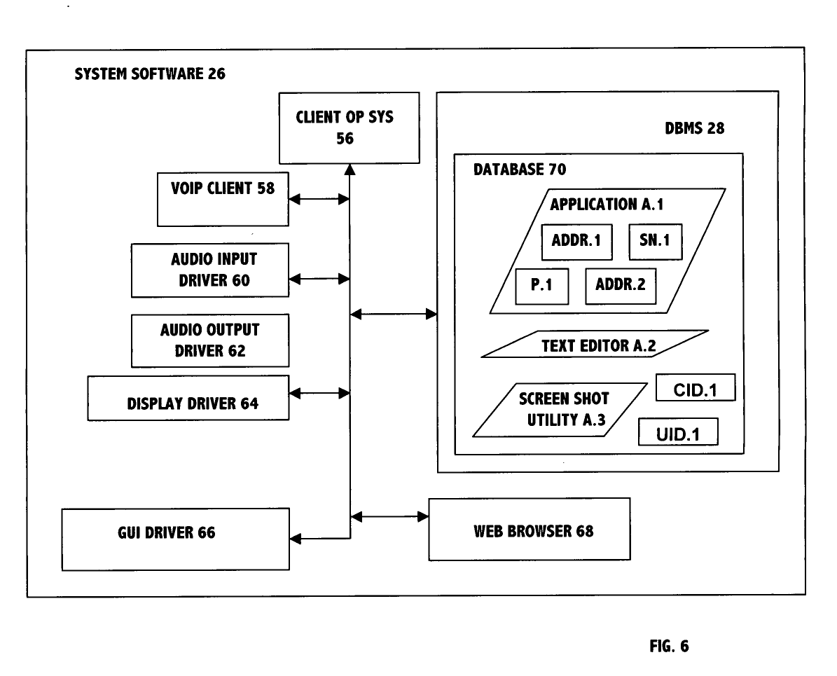

FIG. 6 is an illustration of the system software 26 of the computer 4 of FIGS. 1 and 2. A client operating system 56 enables a VOIP client software module 58 to provide voice data to the network 2 by directing the audio input driver 60 to digitize acoustic signals detected by the audio input device 44 to form a digitized voice record and transmitting the digitized voice record to the CRM workstation 6 via the network 2. It is understood that the VoIP server 8 may facilitate the voice communications between the computer 4 and the CRM workstation 6. The audio output driver 62 processes digitized acoustic signals received from the network 2 and directs the audio output interface 46 and the audio output device 48 to derive and broadcast acoustic signals from the received digitized acoustic signals for hearing by the user.

A display driver 64 directs the video interface 38 and the video screen 40 to visually present information received from, or derived from inputs derived from the network 2, the CRM workstation 6, the VoIP server 8, a GUI driver 66 of the computer 4, the audio input device 44 and/or the input device 42. A web browser 68 may enable the computer 4 to visually display information received from the Internet 10. The software application A.1 is stored in a client database 70 of the DBMS 28, and includes the first support call address ADDR.1, an optional second support call address ADDR.2, the optional product identifier P.1, and the optional serial number SN.1 of the copy of the first software application. Alternatively or additionally, the serial number SN.1 may be associated with, or identify, a license of the first software application A.1. The computer identifier CID.1 and/or the user identifier UID.1 may optionally or additionally be stored in the database 70.

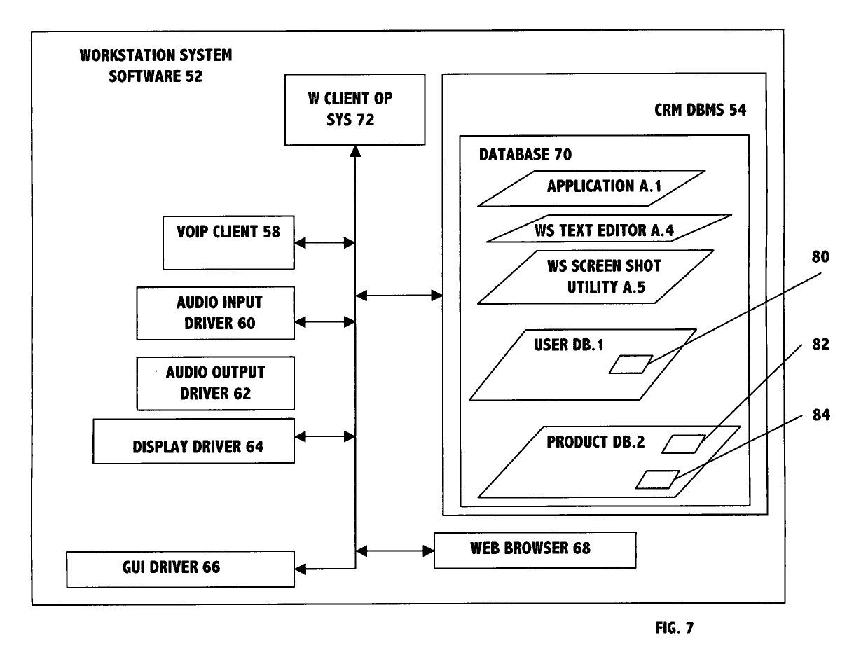

FIG. 7 is an illustration of the workstation system software 52 of the CRM workstation 6 of FIGS. 1 and 2. A workstation operating system 72 (hereinafter, “W ops sys” 72) enables the VOIP client software module 58 to provide voice data to the computer 4 via the network 2 by directing the audio input driver 60 to digitize acoustic signals detected by the audio input device 44 to form a digitized voice record and transmitting the digitized voice record to the computer 4 via the network 2. It is understood that the VoIP server 8 may facilitate the voice communications between the computer 4 and the CRM workstation 6. The audio output driver 62 processes digitized acoustic signals received from the network 2 and directs the audio output interface 46 and the audio output device 48 to derive and broadcast acoustic signals from the received digitized acoustic signals for hearing by the CRM operator.

The display driver 64 directs the video interface 38 and the WS display 55 to visually present information received from, or derived from inputs derived from the network 2, the computer 4, the VoIP server 8, the GUI driver 66, the audio input device 44 and/or the input device 42. The web browser 68 may enable the CRM workstation 6 to visually display information received from the Internet 10.

The CRM DBMS further includes a workstation text editor A.4 (hereinafter, “WS text editor” A.4), a workstation screen shot utility A.5 (hereinafter, “WS screen shot utility” A.5), a user database DB.1 and a product DB.2. The WS editor A.4 enables the CRM workstation 6 to receive textual information comprised within electronic messages generated by the client computer 4 and to display the received textual information on the WS display 55. The WS screen shot utility A.5 enables the CRM workstation 6 to receive screen shot information comprised within electronic messages generated by the client computer 4 and to display the comprised screen shot information on the WS display 55.

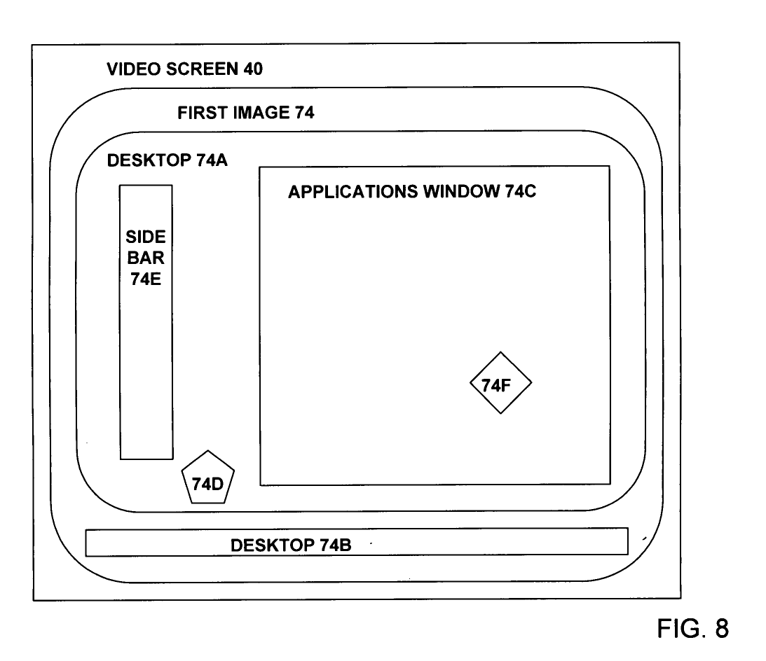

FIG. 8 is an illustration of an image 70 presented on the video screen 40 of the client computer 4 of FIGS. 1, 2 and 6, according to a fifth aspect of the method of the present invention. FIG. 8 is an illustration of a first image 74 presented on the video screen 40 of the client computer 4 of FIGS. 1 and 2, according to a fifth aspect of the method of the present invention. The first image 74 includes a desktop image 74A and a toolbar image 74B. The desktop image 74A includes a first applications window 74C, a first support icon 74D and a first sidebar 74E. The first applications window 74C is rendered by the client computer 4 according to information and instructions received from, or generated during the processing of, the first application A.1. It is understood that the information and instructions processed during the processing of the first application A.1 may include or be at least partially derived information and/or instructions input by the user via the input device 42.

A cursor 74F is positioned within the first image 74 as directed by the user via manipulation of the input device 42. The first support icon 74D may be rendered when the user enables the support function of the client computer 4 as per step 4.02 of the process of FIG. 4. The first support icon 74D may be activated by the user positioning the cursor over the first support icon 74D and the user issuing a selection command, e.g., by clicking a selection button when the input device 42 is a computer mouse.

The activation of the first support icon 74D is an optional aspect of step 4.04 and when detected by the client computer 4 directs the client computer 4 to generate and transmit a voice communications session request for receipt by the CRM workstation 6 as per one or more of the steps 4.08 through 4.20 of the process of FIG. 4. The text editor A.2 enables the user to include text in a communication sent via the network 2 to the CRM workstation 6. The screen capture software utility A.3 enables the user to take a screen shot of the first image 74 and include a digitized representation of the first image 74 in an electronic message sent via the network 2 to the CRM workstation 6.

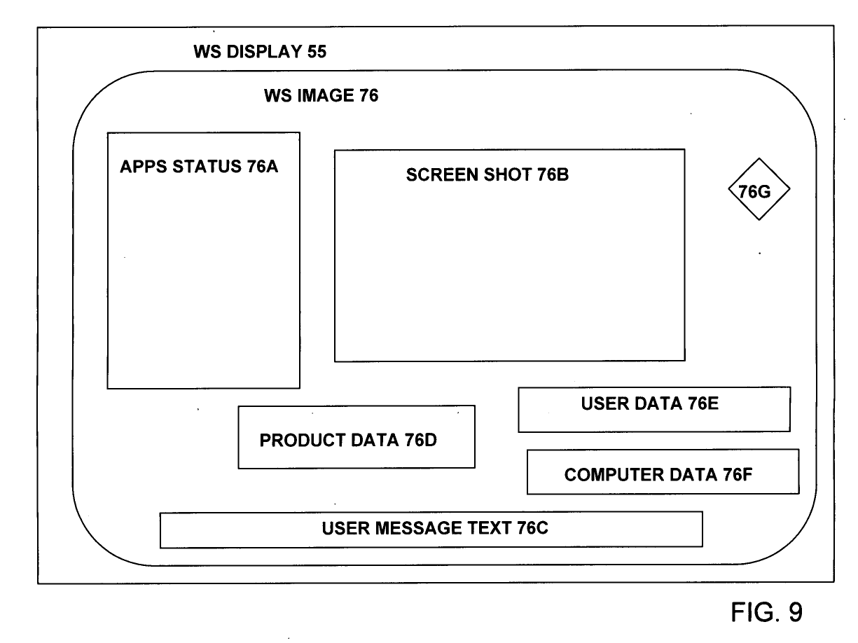

FIG. 9 is an illustration of an image 76 presented on the WS display 55 of the CRM workstation 6 of FIGS. 1 and 3, according to a sixth aspect of the method of the present invention. FIG. 9 is an illustration of a workstation image 76 (hereinafter, “WS image” 76) presented on the WS display 55 of the workstation of FIGS. 1, 3 and 7, according to a sixth aspect of the method of the present invention. The WS image 76 includes an applications status window 76A, a screen shot window 76B, a user text window 76C, a product data window 76D, a user data window 76E and a workstation cursor 76G (hereinafter “WS cursor” 76G). The applications status window 76A, or “APPS STATUS” 76A, is rendered by the CRM workstation 6 according to information and instructions received from the client computer 4 and relating to the status of the first application A.1 as the first application A.1 is being processed by the client computer 4.

The WS cursor 76G are positioned within the WS image 76 as directed by the operator via manipulation of the input device 42 of the CRM workstation 6. The APPS STATUS 76A and other windows 76B-76F of the WS image 76 may be rendered, opened or closed may be rendered when the user directs the CRM workstation 6 to display one or more windows 76A-76E by means of the input device 42 of the CRM workstation 6. For example, the user may direct the CRM workstation 6 to render, open or close a window 76A-76F by positioning the WS cursor 76G and issuing a selection command, e.g., by clicking a selection button when the input device 42 is or comprises a computer mouse.

The activation of the screen shot window 76B causes the CRM workstation 6 to display screen shot information transmitted from the client computer 4 and included in an electronic message received by the CRM workstation 6 to be presented within the product data window 76D. The activation of the user message text window 76C causes the CRM workstation 6 to display textual information transmitted from the client computer 4 and included in an electronic message received by the CRM workstation 6 to be presented within the product data window 76D. The activation of the product data window 76D causes the CRM workstation 6 to display information stored in the product database DB.2 and related to a product associated with the product identifier P.1 to be presented within the product data window 76D. The activation of the user data window 76E causes the CRM workstation 6 to display information stored in the user database DB.1 and related to a user associated with the user identifier UID.1 to be presented within the user data window 76E. The activation of the computer data window 76F causes the CRM workstation 6 to display information stored in the user database DB.1 and related to the client computer 4 associated with the computer identifier CID.1 to be presented within the computer data window 76F.

Voice over IP is the descriptor for the technology used to carry digitized voice over a data network and conforming to the Internet Protocol in accordance with certain aspects of the method of the present invention. VoIP requires two classes of protocols: a signaling protocol such as the session initiation protocol SIP, the H.323 protocol for enabling audiovisual conferencing data to be transmitted over a TCP/IP network, or the Media Gateway Control Protocol (MGCP) signaling and call control protocol, that is used to set up, disconnect and control the calls and telephony features; and a protocol to carry speech packets. The Real-Time Transport Protocol (hereinafter, “RTP”) may define a format of an electronic message M that includes digitized speech data M.V. RTP is an Internet Engineering Task Force standard introduced in 1995 when the H.323 protocol was standardized. RTP is a commonly used protocol that works with numerous private branch exchange systems that conform to the Internet Protocol. A private branch exchange (hereinafter, “PBX”) is a telephone switching system that interconnects telephone extensions to within an internal telephony network as well as to an outside telephone network.

An IP phone or soft phone may generate a voice packet M every 10, 20, 30 or 40 ms, depending on the implementation. The selected 10 to 40 ms of digitized speech can be uncompressed, compressed and even encrypted when transmitted within the RTP packet M. Shorter packets cause less of a problem to verbal communications if the packet M is lost. Short packets require more bandwidth, however, because of increased overhead of the packet M. Longer packets M that contain more speech bytes reduce the bandwidth requirements but produce a longer construction delay but may create more degradation to a verbal communications session when a packet M is lost or degraded in transmission.

The RTP header M.H.RTP may contain a digitized speech sample M.V, e.g., 20 ms or 30 ms, time stamp and sequence number M.TSN and identifies the content of each voice packet M. An RTP content descriptor M.CD may identify and define any applied compression technique used in generating the packet if a compression technique is used. The RTP packet format for VoIP over Ethernet is shown below in Table A.

TABLE A

| | |
|---|---|
| Ethernet Trailer | M.T.E |
| Digitized Voice Data | M.V |
| RTP Header | M.RTPH |
| Time stamp and sequence Number | M.TSN |
| Content descriptor | M.CD |
| UDP Header | M.H.UDP |
| IP Header | M.H.IP |
| Ethernet Header | M.H.E |

RTP packets can be carried (a.) on frame relay networks, (b.) networks operating in accordance with the Asynchronous Transfer Mode cell relay, packet switching network and data link layer protocol, (c.) networks operating in accordance with the Point-to-Point Protocol computer communications protocol; and (d.) certain other prior art electronics networks, with only the Ethernet Header M.H.E and Ethernet Trailer M.T.E varying by protocol. The digitized voice field, RTP header M.RTPH, UDP header M.H.UDP and IP header M.H.IP remain the same.

Each of these RTP packets M may contain part of a digitized spoken word. The packet rate may be 50 packets per second for 20 ms and 33.3 packets per second for 30 ms voice samples. The RTP voice packets M may be transmitted at these fixed rates. The digitized voice data M.V of an RTP packet M can contain as few as 10 bytes of compressed voice information or as many as 320 bytes of uncompressed voice information.

The UDP Header M.H.UDP of the RTP packet M may carry the sending and receiving port numbers for a particular voice communications session. The IP header M.H.IP of the RTP packet M may carry the sending and receiving IP addresses for the call plus other control information. The Ethernet header of the RTP packet M carries the LAN MAC addresses of the sending and receiving devices, e.g., the client computer 4, the CRM workstation 6, the VoIP Server 8 and the wireless server 12. An Ethernet trailer M.T.E of the RTP packet M may be used for error detection purposes. An Ethernet header of the RTP packet M may be replaced with a frame relay, ATM or PPP header and trailer when the RTP packet M enters a Wide Area Network.

The technique of Voice over Internet Protocol requires a transmission of voice information over RTP, and over UDP, and over IP and usually over Ethernet. The headers and trailers of the RTP, UDP, IP and possibly Ethernet Protocol are required fields for the network 2 to carry the RTP packets M.

The RTP Header M.RTPH plus the UDP header M.H.UDP plus the IP header M.H.IP may add on 40 bytes to the RTP packet M. The Ethernet header M.H.E and Ethernet trailer M.E.T may account for another 18 bytes of overhead, for a total of at least 58 bytes of overhead before there are any voice bytes in the RTP packet M. These RTP, UDP and IP headers M.H.RTP, M.H.UDP and M.H.IP, plus the Ethernet header M.H.E, increase an overhead for shipping the RTP packets M. This header overhead of the RTP header M.H.RTP, UDP header M.H.UDP, IP header M.H.IP and Ethernet header M.H.E can range from 20% to 80% of the bandwidth consumed over the LAN and WAN in transmitting RTP packets M. Many implementations of RTP have no encryption, or the vendor has provided its own encryption facilities. Alternatively, many IP PBX vendors offer a standardized secure version of secure, or “SRTP”.

Shorter RTP packets M may have higher overhead. There may be 54 bytes of overhead in an RTP packet M carrying a voice data payload M.V. As the size of the voice data payload M.V of an RTP packet M is increased, the percentage of overhead decreases—therefore the needed bandwidth decreases.

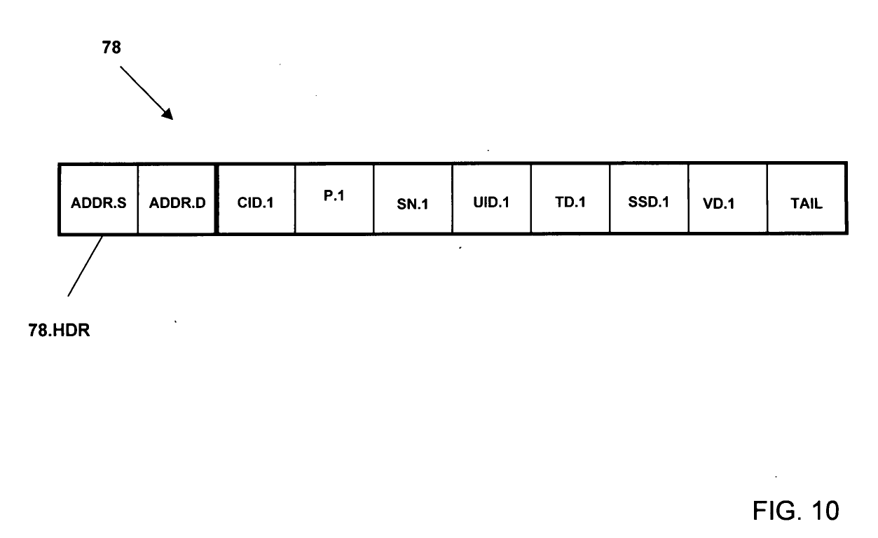

Referring now generally to the Figures and particularly to FIG. 10, FIG. 10 is a schematic drawing of an electronic message 78 formatted for transmission within the network 2 and optionally between the client computer 4 and the CRM workstation 6. A message header 78.HDR includes a message sender network address ADDR.S and a message destination network address ADDR.D. The message sender network address ADDR.S and the message destination network address ADDR.D may be a network address of the client computer 4 or the CRM workstation 6. An optional computer identifier CID.1 identifies the client computer CID.1. An optional product identifier P.1 identifies a software, hardware or system product of interest to the user. An optional serial number SN.1 identifies a particular copy or article of the product line of interest to the user. It is understood that the method of the present invention is not limited to computer products, and that the product identifier P.1 and/or the serial number SN.1 may identify a non-computational product, such as a lawn mower or an article of clothing. An optional user identifier UID.1 identifies the user to the CRM workstation 6 and/or the client computer 4. An optional text data TD.1 comprises textual information provided by the user to the computer client 4 and/or textual information provided by the operator to the CRM workstation 6. An optional screen shot data SSD.1 comprises digitized information representative of an image presented by a video screen 44 or 55 and selected by the user to the computer client 4 and/or selected by the operator to the CRM workstation 6. An optional voice data VD.1 comprises digitized information representative of audio input detected by the audio input device 44 of the client computer 4, and/or digitized information representative of audio input detected by the audio input device 44 of the CRM workstation 6. An optional tail data TAIL may include information conforming to an electronic messaging standard such as the Internet Protocol.

Referring now generally to the Figures and particularly to FIG. 9, FIG. 9 is a schematic drawing of a user record 80 of the user database USER DB.1 of the CRM workstation 6. The user record 80 includes a user record identifier UID.REC that uniquely identifies the user record 80 to the CRM workstation 6. A user permissions information USER.P includes information that directs the CRM workstation 6 to enable access by the user to computational functionalities of. or related to, a product or a service. A user history record USER.H includes information regarding the history of the user, to optionally include a history of interaction between the user and the operator, the CRM workstation 6, and/or the manufacturer and/or marketer of a good or service. A credit account information USER.C includes one or more financial credit or debit account identifiers associated with the user. An optional computer permission data field USER.DF includes the computer identifier CID.1, a computer hardware configuration information C.HW and a software computer configuration information C.SW. The computer hardware configuration information C.HW may include information describing or identifying one or more computer hardware elements comprised within the computer 4. The software computer configuration information C.SW may include information describing or identifying one or more computer software modules comprised within the computer 4.

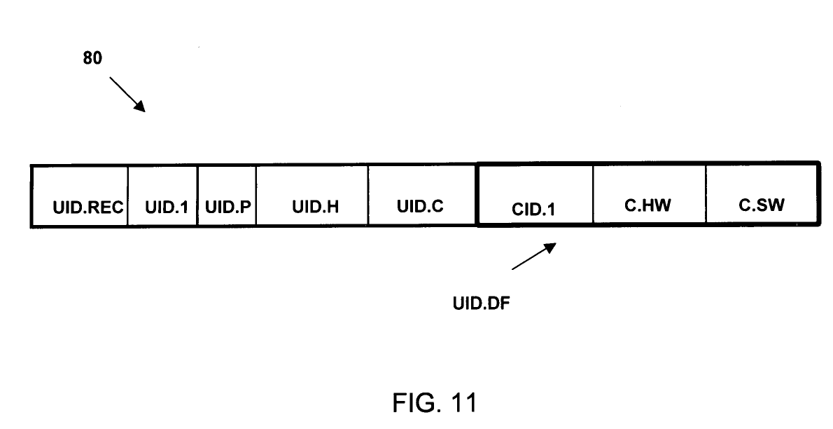

Referring now generally to the Figures and particularly to FIG. 11, FIG. 11 is a schematic drawing of a user record 80 of the user database USER DB. 1 of the CRM workstation 6. The user record 80 includes a user record identifier UID.REC that uniquely identifies the user record 80 to the CRM workstation 6 and the user identifier UID.1. The user identifier UID.1 enables the CRM workstation 6 to associate the user with the user record 80. A user permissions information USER.P includes information that directs the CRM workstation 6 to enable access by the user to computational functionalities of, or related to, a product or a service. A user history record USER.H includes information regarding the history of the user, to optionally include a history of interaction between the user and the operator, the CRM workstation 6, and/or the manufacturer and/or marketer of a good or service. A credit account information USER.C includes one or more financial credit or debit account identifiers associated with the user. An optional computer configuration data field USER.DF includes the computer identifier CID. 1, a computer hardware configuration information C.HW and a software computer configuration information C.SW. The computer hardware configuration information C.HW may include information describing or identifying one or more computer hardware elements comprised within the computer 4. The software computer configuration information C.SW may include information describing or identifying one or more computer software modules comprised within the computer 4.

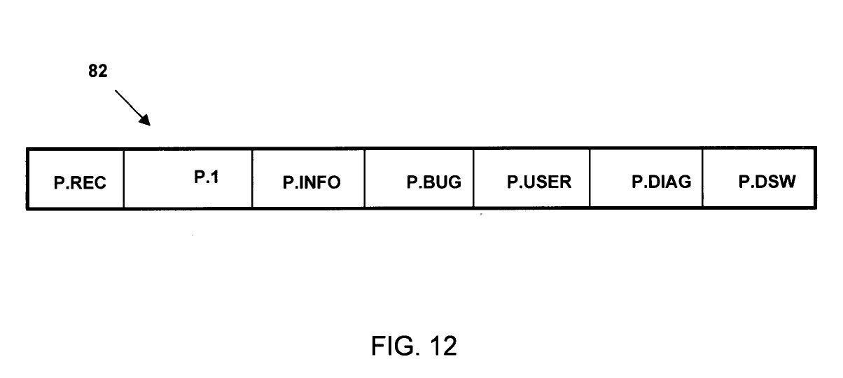

According to still additional aspects of the method of the present invention, some or all of the information contained within the user history record USER.H, the credit account information USER.C, and/or the computer configuration data field USER.DF. Referring now generally to the Figures and particularly to FIG. 12, FIG. 12 is a schematic drawing of a product record 82 of the product database DB.2 of the CRM workstation 6. The product record 82 includes both a product record identifier P.REC that uniquely identifies the product record 82 to the CRM workstation 6, and the product identifier P.1. A product information P.INFO includes textual and/or graphic information pertaining to the product identified by the product identifier P.1. A bug/defect report information P.BUG includes textual and/or graphic information pertaining to software bug reports and product defect reports identified by the product identified by the product identifier P.1. A user guide information P.USER includes textual and/or graphic information describing how to use the product identified by the product identifier P.1. A product diagnostic information P.DIAG includes textual and/or graphic information describing how to diagnose a source of user difficulties with the product identified by the product identifier P.1. A diagnostic software P.DSW includes software-encoded instructions that may be run on the client computer 4 and/or workstation 6 and structured to diagnose a source of user difficulties with the product identified by the product identifier P.1.

According to yet additional aspects of the method of the present invention, some or all of the product information P.INFO, the bug/defect report information P.BUG, the user guide information P.USER, and/or the product diagnostic information P.DIAG may be displayed in the product data window 76D.

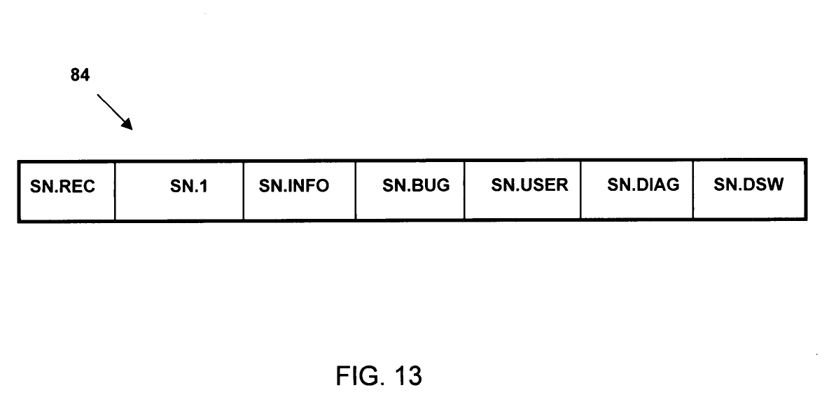

Referring now generally to the Figures and particularly to FIG. 13, FIG. 13 is a schematic drawing of a serialized record 84 of the product database DB.2 of the CRM workstation 6. The serialized record 84 includes both a serialized record identifier SN.REC that uniquely identifies the serialized record 84 to the CRM workstation 6, and the serial number SN.1. A serialized product information SN.INFO includes textual and/or graphic information pertaining to an article, software, document, license or copy identified by the serial number SN.1. A serialized bug/defect report information SN.BUG includes textual and/or graphic information pertaining to software bug reports and/or product defect reports associated with an article, software, document, license or copy identified by the serial number SN.1. A serialized user guide information SN.USER includes textual and/or graphic information describing how to use an article, document or copy identified by the serial number SN.1. A serialized product diagnostic information SN.DIAG includes textual and/or graphic information describing how to diagnose a source of user difficulties with an article, software or copy identified by the serial number SN.1. A diagnostic software SN.DSW includes software-encoded instructions that may be run on the client computer 4 and/or workstation 6 and structured to diagnose a source of user difficulties with the product identified by the serial number SN.1.

According to even additional aspects of the method of the present invention, some or all of the serialized product information SN.INFO, the serialized bug/defect report information SN.BUG, the serialized user guide information SN.USER, and/or the serialized product diagnostic information SN.DIAG may be displayed in the product data window 76D.

Based on the foregoing, it should be appreciated that the various embodiments of the invention include a method, system, apparatus, and computer-readable medium for managing a VoIP communications session. The above specification, examples and data provide a complete description of the manufacture and use of the composition of the invention. Since many aspects of the invention can be generated without departing from the spirit and scope of the invention, the invention resides in the claims hereinafter appended. Alternative embodiments and implementations of the present invention will become apparent to those skilled in the art to which it pertains upon review of the specification, including the drawing figures. Accordingly, the scope of the present invention is defined by the appended claims rather than the foregoing description.

I claim:

1. In a computer network comprising a computer and a support workstation, a method for providing real time support to a computer user, the method comprising:
receiving a support request at the workstation via the computer network;
initiating a communications session between the computer and the workstation; and
establishing a real time discussion between a user of the computer and an operator of the workstation, wherein the operator attempts to support the user in achieving a goal by means of the computer network.

2. The method of claim 1, wherein the support request comprises at least part of a problem description.

3. The method of claim 1, wherein the discussion is facilitated by textual communication.

4. The method of claim 1, wherein the communications session comprises bi-directional voice transmission and the discussion is facilitated by audible communication.

5. The method of claim 4, wherein the bi-directional voice transmission is enabled via a voice over Internet channel.

6. The method of claim 4, wherein the bi-directional voice transmission is enabled via a telephony channel.

7. The method of claim 1, further comprising providing the workstation operator with a screen shot of a video display of the computer.

8. The method of claim 1, further comprising providing the workstation operator with a contemporaneous view of a video display the computer, whereby the operator sees what is dynamically presented on the video display.

9. The method of claim 1, wherein the support request includes an identifier of the computer.

10. The method of claim 9, wherein the identifier of the computer is applied by the workstation to access a profile of the computer.

11. The method of claim 1, wherein the support request includes an account identifier associated with the user.

12. The method of claim 11, wherein the account identifier is applied by the workstation to access a profile of a referenced account.

13. The method of claim 1, wherein the support request is initiated by the user selected a support icon visually presented on a display screen of the computer.

14. The method of claim 13, wherein the discussion is facilitated by textual communication.

15. The method of claim 13, wherein the communications session comprises bi-directional voice transmission and the discussion is facilitated by audible communication.

16. The method of claim 15, wherein the bi-directional voice transmission is enabled via a voice over Internet channel.

17. The method of claim 15, wherein the bi-directional voice transmission is enabled via a telephony channel.

18. The method of claim 13, further comprising providing the workstation operator with a contemporaneous view of a video display the computer, whereby the operator sees what is dynamically presented on the video display.

19. A computer, comprising:
means to bi-directionally communicatively couple the computer with the Internet;
means to transmit a support request to a workstation via the Internet;
means to initiate a voice over Internet communications session between the computer and the workstation; and
means to establish a real time audible discussion between a user of the computer and an operator of the workstation, wherein the operator attempts to support the user in achieving a goal by means of the Internet.

20. A computer-readable medium comprising machine-readable instructions which when executed by a computer cause the computer to perform a method comprising:
transmit a support request to a workstation via a computer network; and
initiate an audio communications session between the computer and the workstation;
enable a real time discussion between a user of the computer and an operator of the workstation, wherein the operator attempts to support the user in achieving a goal by means of the computer network.
